(19) United States
(12) Patent Application Publication
(10) Pub. No.: US 2018/0279836 A1
(43) Pub. Date: Oct. 4, 2018

(54) INTERLOCKING DEVICE WITH AN INTEGRATED HANDLE FOR PRESSURE COOKER INSERT PANS

(71) Applicants: Sanjiv Rajagopal Prithviraj, Cary, NC (US); Preetha Radhakrishnan, Cary, NC (US)

(72) Inventors: Sanjiv Rajagopal Prithviraj, Cary, NC (US); Preetha Radhakrishnan, Cary, NC (US)

(73) Assignee: Sanjiv Rajagopal Prithviraj, Cary, NC (US)

(21) Appl. No.: 15/477,222

(22) Filed: Apr. 3, 2017

(51) Int. Cl. A47J 45/07; B65D 21/02

(52) U.S. Cl. CPC A47J 45/07; B65D 21/0224

(57) ABSTRACT

An interlocking device for a stackable container system such as stackable storage or cooking containers is disclosed. The interlocking device comprises a base plate and an interlocking assembly for securely locking the stackable containers. The base plate is configured to securely holding the bottom portion of the base container of the stackable container system. The interlocking assembly with two or more holders connected to either side of the said base plate of the interlocking device. An end of the holder from a side of the base plate is incorporated with a hook structure, and the other end of the holder from another side of the base plate is incorporated with a retaining structure, configured to lock each end of the holders. The hook structure of the holder is attached with a handle, thereby providing ease on locking and handling the stackable container system to a user.

### BACKGROUND OF THE INVENTION

A. Technical Field

The present invention generally relates to an interlocking device, and more specifically relates to the interlocking device with an integrated handle for pressure cooker inserts such as stackable stainless steel pans or single layer pan such as cake pan, springform pan, glass bowl, etc.

B. Description of Related Art

Storage or cooking containers are stacked one above the other for filling food or liquid or any objects for fulfilling user's required functionality. Each container could be closed with or without lid while stacking containers one above the other. This container consists of a locking latch assembly, or a catch assembly, helps in firmly locking all the stacked containers. The stackable containers are easily opened to use by unlocking a catch or snap fastener on either side.

A proposed prior art attempted to firmly locking the stackable container is, Raymond Tuccio, U.S. Pat. No. 3,219,179 discloses a flat lunch box comprising a bottom panel, a rear and top panel connected to the bottom panel and hinged upwardly along the fold line at a rear edge of the bottom panel, and a means secured at a front edge of the bottom panel for meeting with the rear and top panel. Two side panels are connected to the bottom panel, are hinged upwardly along fold lines at respective side edges of the bottom panel. The side panels have respective curved ends remote from the bottom panel whereby to establish a curved top profile when these side panels stand upward from the bottom panel. However, the existing arts lack in implementing a simple locking device integrated with handle for the stackable container system.

Therefore, there is a need in the art for an interlocking device designed with an improved locking mechanism with simple and inexpensive construction for the various kinds of pressure cooker insert pans. There is also a need for the interlocking device for the stackable container system providing ease on using the stackable container system with an interlocking device, which could be carried easily by an integrated handle to the locking device.

### SUMMARY OF THE INVENTION

The present invention to an interlocking device integrated with a handle for pressure cooker insert pan. The insert pans could be a stackable, containing two layer of pans or could be single pan such as a cake pan, springform pan or glass bowl. In an embodiment, the interlocking device comprises a base plate and an interlocking assembly, for securely locking or holding the stackable containers.

In one embodiment, the base plate is configured to securely holding the bottom portion of the base container of the stackable container system. In another embodiment, the interlocking assembly with two or more holders hingeably connected to either side of the said base plate of the interlocking device. Further, the length of the holders is extended along the height of the stackable container system and curved along the edges of the top container.

In one embodiment, one end of the holder from a side of the base plate is incorporated with a hook structure. In another embodiment, the other end of the holder from another side of the base plate is incorporated with a retaining structure for retaining inside the said hook structure. The ends of the holder are opposing in orientation, which is configured to lock each end of the holders towards the stackable container system. Further, the hook structure of the said holder is hingeably attached with a handle, thereby providing ease on locking and handling the stackable container system to a user.

In an embodiment, the holders are faced opposing in orientation from either side of the base plate of the interlocking device. In one embodiment, the holder is rod shaped structure hingeably connected to either side of the said base plate. In another embodiment, the holder is flat plate shaped structure hingeably connected to either side of the said base plate. In some embodiments, the hook structure of the interlocking device could be a loop element, or any grabbing element. In some embodiments, the retaining structure could be a retainer, or any flat rod, configured to retain or lock the said hook structure.

In one embodiment, the stackable container system could be selected from any one of container comprising a stackable pan, a stackable bowl, or a stackable box. In another embodiment, the stackable pan is selected from a group comprising anyone of cake pan, plastic pan, stainless steel pan, and food cooking pan and springform pan. In another embodiment, the stackable bowl is selected from a group comprising anyone of pyrex glass bowl, plastic bowl, stainless steel bowl, and food cooking bowl. In one embodiment, the handle is a rod element, a gripping element, a hook element or any holdable element for the user, integrated to the said interlocking device for the stackable containers. In some embodiments, the interlocking device is further made of a material compatible with the material incorporated for the stackable container system. In some embodiments, the holder could be configured to hold single container, for example, single pan, single box, or single glass bowl, etc.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 shows a top perspective view of an interlocking device integrated with a handle for a stackable container system.

FIG. 2 shows a front exploded view of a stackable container system without enclosing inside the interlocking device.

FIG. 3 shows a top exploded view of the stackable container system about to enclose inside the interlocking device.

FIG. 4 shows a top perspective view of the stackable container system with the interlocking device.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore indicated by the appended claims rather than by the foregoing description. All changes that come within the meaning and range of equivalency of the claims are to be embraced within their scope.

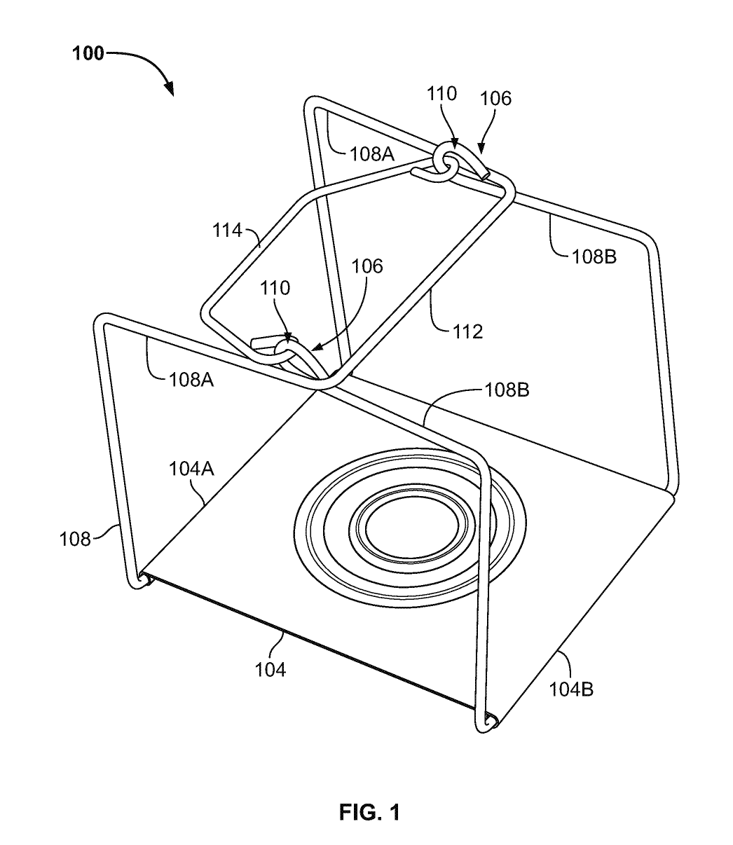

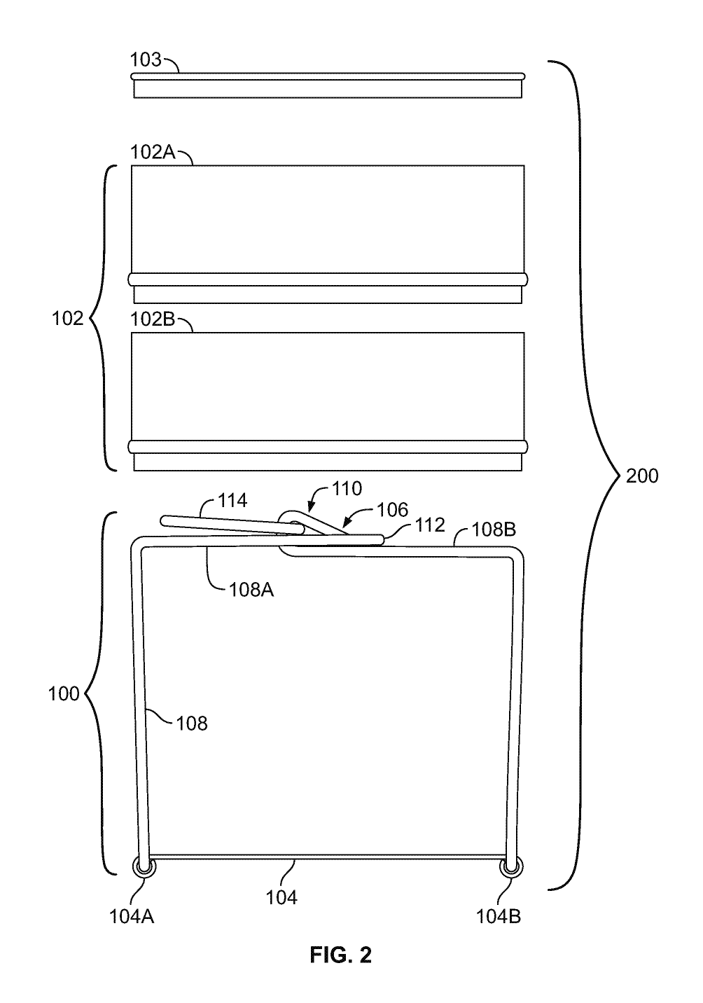

Referring to FIG. 1, a top perspective view of an interlocking device 100 integrated with a handle 114 according to an embodiment. Referring to FIG. 2, a front exploded view of the stackable container system 200 without enclosing inside the interlocking device 100 according to an embodiment. The stackable container system 200 could be a stackable storage or cooking container system comprises one or more containers 102. In some embodiments, the containers 102 are securely covered by means of a lid 103. In an embodiment, the interlocking device 100 comprises a base plate 104 and an interlocking assembly 106, for securely locking or holding the stackable containers 102.

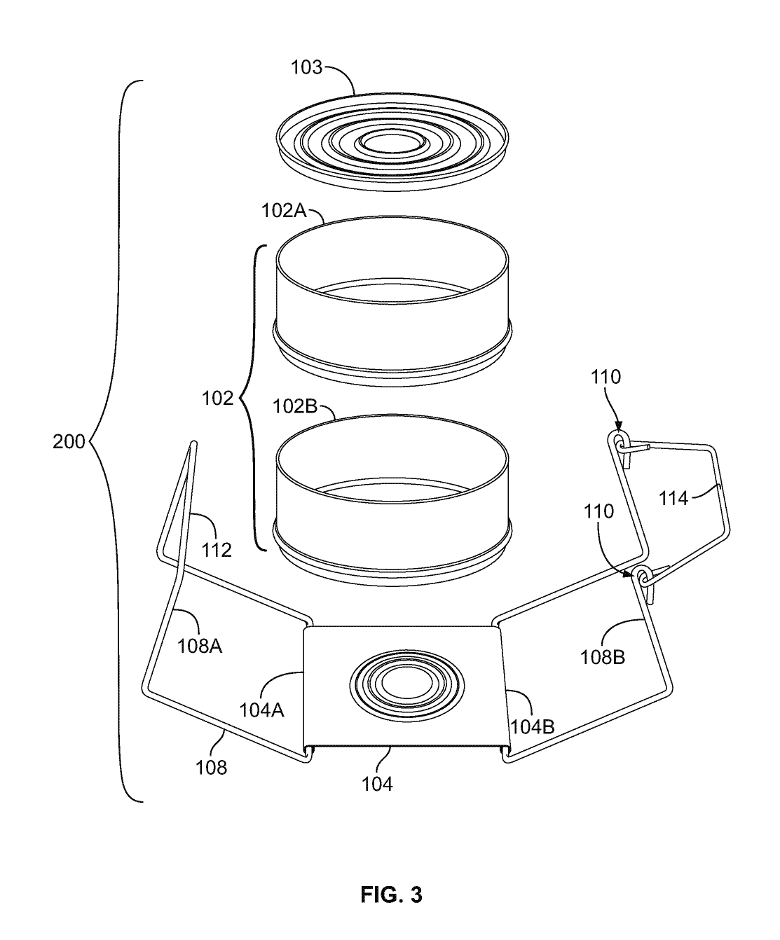

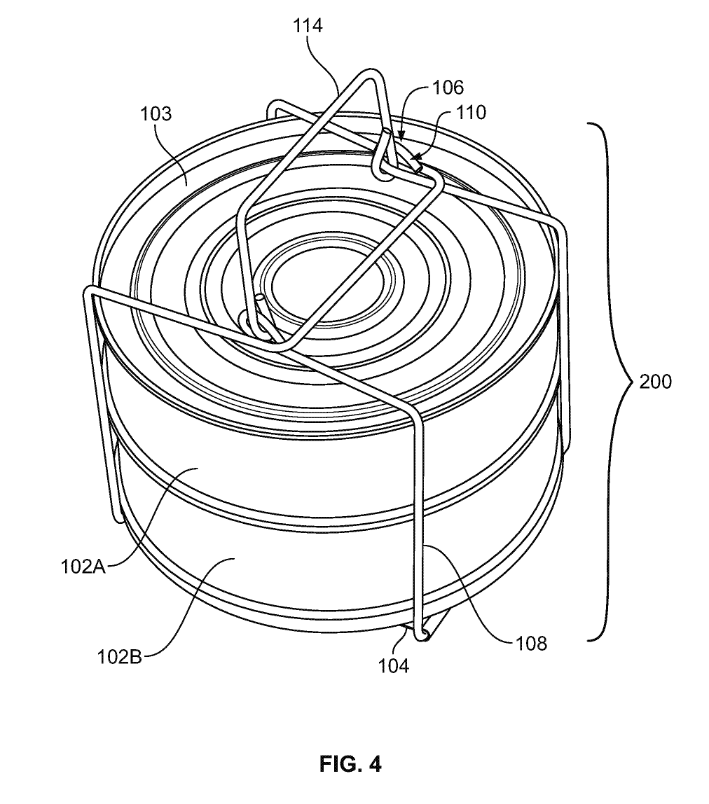

Referring to FIG. 3 and FIG. 4, illustrates a top exploded view of the stackable container system 200 comprising the interlocking device 100 integrated with handle 114, and a top perspective view of the stackable container system 200 enclosed inside the interlocking device 100 respectively, according to an embodiment. In one embodiment, the base plate 104 is configured to securely holding the bottom portion of the base container 102A of the stackable container system 200. In another embodiment, the interlocking assembly 106 with two or more holders 108 hingeably connected to either side (104A, 104B) of the said base plate 104 of the interlocking device 100. Further, the length of the holders 108 is extended along the height of the stackable container system 200 and curved along the edges of the top container 102B. In some embodiment, the curved section could be a bent portion with a catch to hold the sides of the top container 102B.

In one embodiment, one end 108A of the holder 108 from another side 104A of the base plate 104 is incorporated with a retaining structure 112 for securely retaining or holding inside the said hook structure 110. In another embodiment, other end 108B of the holder 108 from a side 104B of the base plate 104 is incorporated with a hook structure 110. The ends (108A, 108B) of the holder 108 are opposing in orientation, which is configured to lock each end (108A, 108B) of the holders 108 towards the stackable container system 200. Further, the hook structure 110 of the said holder 108 is hingeably attached with a handle 114, thereby providing ease on locking and handling the stackable container system 200 to a user.

In an embodiment, the holders 108 are faced opposing in orientation from either side of the base plate 104 of the interlocking device 100. In one embodiment, the holder 108 is rod shaped structure hingeably connected to either side (104A, 104B) of the said base plate 104. In another embodiment, the holder 108 is flat plate shaped structure hingeably connected to either side (104A, 104B) of the said base plate 104. In some embodiments, the hook structure 110 of the interlocking device 100 could be a loop element, or any grabbing element. In some embodiments, the retaining structure 112 could be a retainer, or any flat rod, configured to retain or lock the said hook structure 110.

In one embodiment, the stackable container system 200 could be selected from any one of container 102 comprising a stackable pan, a stackable bowl, or a stackable box. In another embodiment, the stackable pan is selected from a group comprising anyone of cake pan, plastic pan, stainless steel pan, and food cooking pan, and springform pan. In another embodiment, the stackable bowl is selected from a group comprising anyone of pyrex glass bowl, plastic bowl, stainless steel bowl, and food cooking bowl. In one embodiment, the handle 114 is a rod element, a gripping element, a hook element or any holdable element for the user, integrated to the said interlocking device 100 for the stackable container system 200. In some embodiments, the interlocking device 100 is further made of a material compatible with the material incorporated for the stackable container system 200. The materials could be metallic or non-metallic materials, such as stainless steel, plastic, or any polymer materials. In some embodiments, the holder 108 could be configured to hold at least one container 102, for example, single pan, single box, or single bowl, etc.

The advantage of the interlocking device 100 is simple in construction, and cost-effective comparing to the existing arts. The interlocking device 100 integrated with the handle 114 for the stackable container system 200 provides a simple mode of locking mechanism to the user. The integrated handle 114 design ensures safety, where it further replaces existing usage of tongs or sling foil to lift pans out of the pressure cooker, or any other cooking equipment/device. The interlocking device 100 integrated with the handle 114 could be manufactured with any finishing, coating, or with any bright or trending colors and designs.

[23] The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. An interlocking device for a stackable container system, comprising:
a base plate, wherein the base plate is configured to securely holding the bottom portion of the base container of the stackable container system;
an interlocking assembly with two or more holders hingeably connected to either side of the said base plate with a length extending along the height of the stackable container system and curved along the edges of the top container; wherein an end of the holder from a side of the base plate is incorporated with a hook structure, and other end from another side of the base plate is incorporated with a retaining structure for retaining inside the said hook structure, configured to lock each end of the holders towards the stackable container system, and wherein the hook structure of the said holder is hingeably attached with a handle, thereby providing ease on locking and handling the stackable container system to a user.

2. The interlocking device of claim 1, wherein the holders are faced opposing in orientation from either side of the base plate.

3. The interlocking device of claim 1, wherein the holder is rod shaped structure hingeably connected to either side of the said base plate.

4. The interlocking device of claim 1, wherein the holder is flat plate shaped structure hingeably connected to either side of the said base plate.

5. The interlocking device of claim 1, wherein the hook structure is a loop element.

6. The interlocking device of claim 1, wherein the stackable container system are a stackable pans, a stackable bowls, or a stackable boxes.

7. The interlocking device of claim 6, wherein the stackable pan are cake pan, plastic pan, stainless steel pan, and food cooking pan and springform pan.

8. The interlocking device of claim 6, wherein the stackable bowl are pyrex glass bowl, plastic bowl, stainless steel bowl, and food cooking bowl.

9. The interlocking device of claim 1, wherein the handle is a rod element, a gripping element, a hook element or a holdable element, integrated to the said interlocking device for the stackable containers.

10. The interlocking device of claim 1, further made of a material compatible with the material incorporated for the stackable container system.

11. The interlocking device of claim 1, where in the holder can be configured to enclose a single layer pan.

12. The interlocking device of claim 11, wherein the single layer pan are a cake pan, stainless steel pan and springform pan.
